(19) United States
(12) Patent Application Publication
(10) Pub. No.: US 2011/0292369 A1
(43) Pub. Date: Dec. 1, 2011

(54) SUBSTRATE TABLE, A LITHOGRAPHIC APPARATUS, A METHOD OF FLATTENING AN EDGE OF A SUBSTRATE AND A DEVICE MANUFACTURING METHOD

(75) Inventors: Raymond Wilhelmus Louis LAFARRE, Helmond (NL); Niek Jacobus Johannes ROSET, Eindhoven (NL); Martijn HOUBEN, 's-Hertogenbosch (NL)

(73) Assignee: ASML NETHERLANDS B.V., Veldhoven (NL)

(21) Appl. No.: 13/105,404

(22) Filed: May 11, 2011

Related U.S. Application Data
(60) Provisional application No. 61/334,299, filed on May 13, 2010.

(51) Int. Cl. G03B 27/58; G03B 27/32

(52) U.S. Cl. 355/72; 355/77

(57) ABSTRACT

A substrate table to support a substrate is disclosed. The substrate table includes a substrate support to support the substrate and to apply a bending force to an edge of the substrate in a first direction. A substrate edge manipulator is provided that is configured to apply a variable bending force to the edge of the substrate in a second direction, which second direction has at least a component opposite in direction to the first direction.

This application claims priority and benefit under 35 U.S.C. §119(e) to U.S. Provisional patent application Ser. No. 61/334,299, filed on May 13, 2010. The contents of the foregoing application is incorporated herein in its entirety by reference.

### FIELD

The present invention relates to a substrate table, a lithographic apparatus, a method of flattening an edge of a substrate and a device manufacturing method

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It has been proposed to immerse the substrate in the lithographic projection apparatus in a liquid having a relatively high refractive index, e.g. water, so as to fill a space between the final element of the projection system and the substrate. In an embodiment, the liquid is distilled water, although another liquid can be used. An embodiment of the invention will be described with reference to liquid. However, another fluid may be suitable, particularly a wetting fluid, an incompressible fluid and/or a fluid with higher refractive index than air, desirably a higher refractive index than water. Fluids excluding gases are particularly desirable. The point of this is to enable imaging of smaller features since the exposure radiation will have a shorter wavelength in the liquid. (The effect of the liquid may also be regarded as increasing the effective numerical aperture (NA) of the system and also increasing the depth of focus.) Other immersion liquids have been proposed, including water with solid particles (e.g. quartz) suspended therein, or a liquid with a nano-particle suspension (e.g. particles with a maximum dimension of up to 10 nm). The suspended particles may or may not have a similar or the same refractive index as the liquid in which they are suspended. Other liquids which may be suitable include a hydrocarbon, such as an aromatic, a fluorohydrocarbon, and/or an aqueous solution.

Submersing the substrate or substrate and substrate table in a bath of liquid (see, for example, U.S. Pat. No. 4,509,852) means that there is a large body of liquid that must be accelerated during a scanning exposure. This requires additional or more powerful motors and turbulence in the liquid may lead to undesirable and unpredictable effects.

In an immersion apparatus, immersion fluid is handled by a fluid handling system, device structure or apparatus. In an embodiment the fluid handling system may supply immersion fluid and therefore be a fluid supply system. In an embodiment the fluid handling system may at least partly confine immersion fluid and thereby be a fluid confinement system. In an embodiment the fluid handling system may provide a barrier to immersion fluid and thereby be a barrier member, such as a fluid confinement structure. In an embodiment the fluid handling system may create or use a flow of gas, for example to help in controlling the flow and/or the position of the immersion fluid. The flow of gas may form a seal to confine the immersion fluid so the fluid handling structure may be referred to as a seal member; such a seal member may be a fluid confinement structure. In an embodiment, immersion liquid is used as the immersion fluid. In that case the fluid handling system may be a liquid handling system. In reference to the aforementioned description, reference in this paragraph to a feature defined with respect to fluid may be understood to include a feature defined with respect to liquid.

In lithographic exposure apparatus a substrate is supported by a substrate support of a substrate table comprising burls (projections). The substrate is typically sucked to the substrate table by applying a vacuum. In an immersion system (i.e. a system that supplies an immersion liquid between a projection system and the substrate when exposing the substrate) the substrate table often comprises a seal to seal the immersion liquid from the vacuum space between the substrate and the substrate table.

### SUMMARY

It is desirable to have the edge of the substrate as flat as possible. Accordingly, the edge of the substrate can be kept as flat as possible.

This can be done by choosing an optimal burl pattern in combination with seal positions (and when more vacuum zones are present a relative pressure difference between the zones). However, this assumes that all substrates are ideally flat and with a constant thickness. Also, the substrate and the substrate support are presumed to be perfectly clean and the substrate support is presumed to be manufactured with a position tolerance of 0.

In reality, one or more coatings, substrate processing, and contamination cause a disturbance of the edge flatness which may vary per substrate. Additionally or alternatively, wrong vacuum settings and/or tolerances on the manufacturing of the burl pattern cause a constant offset in the edge flatness. This may lead to defocus on the edge which may give a penalty not only in performance, but also in yield since these areas cannot be exposed at all. The edge performance can change over time due to contamination and/or wear and can lead to a reduction in performance and yield over time.

It is desirable, for example, to provide a substrate table which can adjust the flatness of a substrate edge.

According to an aspect, there is provided a substrate table to support a substrate, the substrate table comprising: a substrate support to support the substrate and to apply a bending force to an edge of the substrate in a first direction; and a substrate edge manipulator configured to apply a variable bending force to the edge of the substrate in a second direction, the second direction having at least a component opposite in direction to the first direction.

According to an aspect, there is provided a substrate table to support a substrate, the substrate table comprising: a member configured, in use, to bend an edge of a substrate supported by the substrate table by physical contact with an upper major face of the substrate.

According to an aspect, there is provided a method of flattening an edge of a substrate, the method comprising: applying a force to an edge of the substrate sufficient to induce the edge of the substrate to bend in a first direction; and applying a variable force to the edge of the substrate in a second direction substantially opposite in direction to the first direction to improve the flatness of the edge of the substrate.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2 and 3 depict a liquid supply system for use in a lithographic projection apparatus;

FIG. 4 depicts a further liquid supply system for use in a lithographic projection apparatus;

FIG. 5 depicts a further liquid supply system for use in a lithographic projection apparatus;

FIG. 6 illustrates, in cross-section, a substrate table according to an embodiment;

FIG. 7 illustrates, in cross-section, a substrate table according to an embodiment;

FIG. 8 illustrates, in cross-section, a substrate table according to an embodiment;

FIG. 9 illustrates, in plan, the substrate table of FIG. 7; and

FIG. 10 illustrates, in plan, a substrate table of an embodiment.

### DETAILED DESCRIPTION

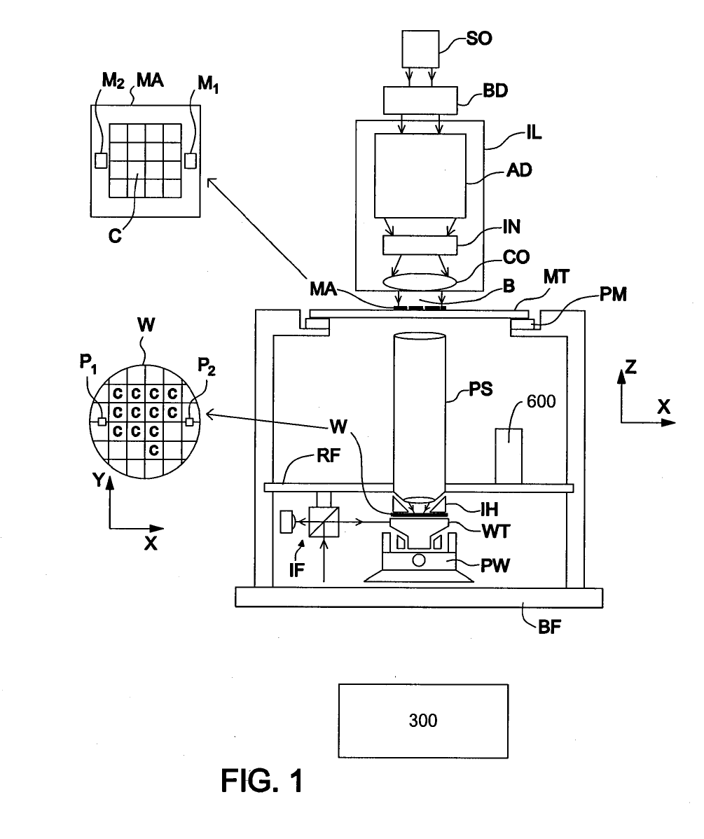

FIG. 1 schematically depicts a lithographic apparatus according to an embodiment of the invention. The apparatus comprises:

an illumination system (illuminator) IL configured to condition a radiation beam B (e.g. UV radiation or DUV radiation);

a support structure (e.g. a mask table) MT constructed to support a patterning device (e.g. a mask) MA and connected to a first positioner PM configured to accurately position the patterning device MA in accordance with certain parameters;

a substrate table (e.g. a wafer table) WT constructed to hold a substrate (e.g. a resist-coated wafer) W and connected to a second positioner PW configured to accurately position the substrate W in accordance with certain parameters; and

a projection system (e.g. a refractive projection lens system) PS configured to project a pattern imparted to the radiation beam B by patterning device MA onto a target portion C (e.g. comprising one or more dies) of the substrate W.

The illumination system IL may include various types of optical components, such as refractive, reflective, magnetic, electromagnetic, electrostatic or other types of optical components, or any combination thereof, for directing, shaping, or controlling radiation.

The support structure MT holds the patterning device MA. It holds the patterning device MA in a manner that depends on the orientation of the patterning device MA, the design of the lithographic apparatus, and other conditions, such as for example whether or not the patterning device MA is held in a vacuum environment. The support structure MT can use mechanical, vacuum, electrostatic or other clamping techniques to hold the patterning device MA. The support structure MT may be a frame or a table, for example, which may be fixed or movable as required. The support structure MT may ensure that the patterning device MA is at a desired position, for example with respect to the projection system PS. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device MA may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more tables at least one or all of which may hold a substrate (and/or two or more patterning device tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source SO and the lithographic apparatus may be separate entities, for example when the source SO is an excimer laser. In such cases, the source SO is not considered to form part of the lithographic apparatus and the radiation beam is passed from the source SO to the illuminator IL with the aid of a beam delivery system BD comprising, for example, suitable directing mirrors and/or a beam expander. In other cases the source SO may be an integral part of the lithographic apparatus, for example when the source SO is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator IL can be adjusted. In addition, the illuminator IL may comprise various other components, such as an integrator IN and a condenser CO. The illuminator IL may be used to condition the radiation beam, to have a desired uniformity and intensity distribution in its cross-section. Similar to the source SO, the illuminator IL may or may not be considered to form part of the lithographic apparatus. For example, the illuminator IL may be an integral part of the lithographic apparatus or may be a separate entity from the lithographic apparatus. In the latter case, the lithographic apparatus may be configured to allow the illuminator IL to be mounted thereon. Optionally, the illuminator IL is detachable and may be separately provided (for example, by the lithographic apparatus manufacturer or another supplier).

The radiation beam B is incident on the patterning device (e.g., mask) MA, which is held on the support structure (e.g., mask table) MT, and is patterned by the patterning device MA. Having traversed the patterning device MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions C (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the support structure MT and the substrate table WT are kept essentially stationary, while an entire pattern imparted to the radiation beam B is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam B is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion C in a single dynamic exposure, whereas the length of the scanning motion determines the height (in the scanning direction) of the target portion C.

3. In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

An embodiment of the invention is applied to a lithographic apparatus, particularly an immersion lithographic apparatus. An embodiment of the invention is applied to a non-immersion lithographic apparatus, for example to an EUV lithographic apparatus. Examples of immersion lithographic apparatus are described below because the substrate edge manipulator described herein can additionally function as a seal which seals a gap between the edge of the substrate W and a top surface of the substrate table WT, which is desirable in an immersion apparatus. However, the principles described below are equally applicable to a non-immersion apparatus.

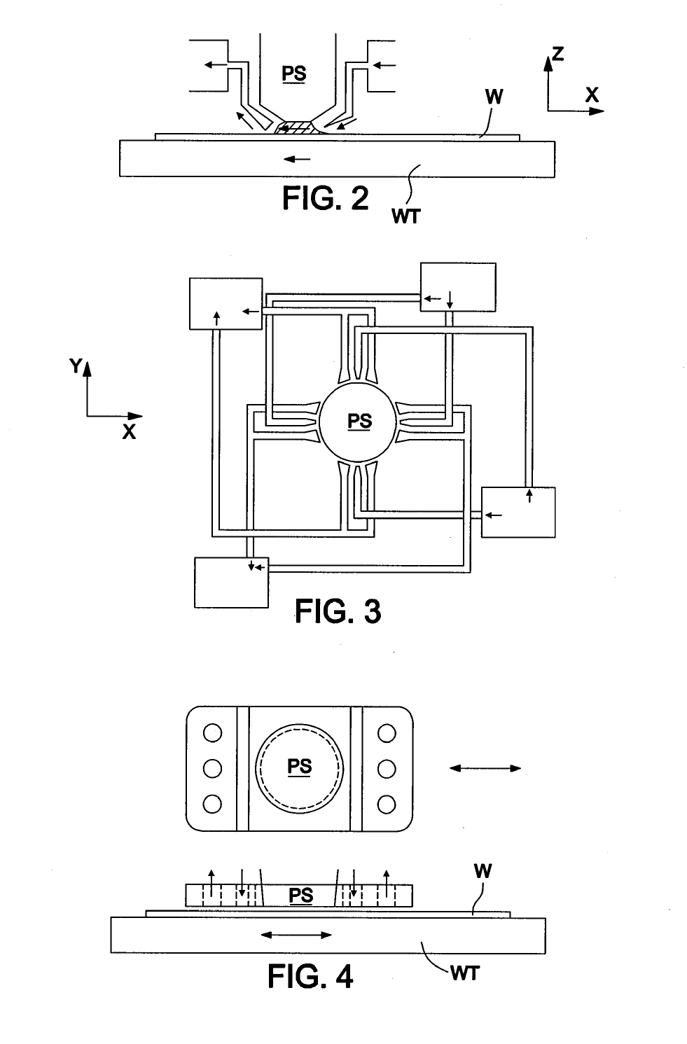

Arrangements for providing liquid between a final element of the projection system and the substrate can be classed into at least three general categories. Two general categories are the bath type arrangement and the so called localized immersion system. In the bath type arrangement substantially the whole of the substrate and optionally part of the substrate table is submersed in a bath of liquid. The so called localized immersion system uses a liquid supply system in which liquid is only provided to a localized area of the substrate. In the latter category, the space filled by liquid is smaller in plan than the top surface of the substrate and the area filled with liquid remains substantially stationary relative to the projection system while the substrate moves underneath that area. A further category, to which an embodiment of the invention is directed, is the all wet solution in which the liquid is unconfined. In this arrangement substantially the whole top surface of the substrate and all or part of the substrate table is covered in immersion liquid. The depth of the liquid covering at least the substrate is small. The liquid may be a film, such as a thin film, of liquid on the substrate. Any of the liquid supply devices of FIGS. 2-5 may be used in such a system; however, sealing features are not present, are not activated, are not as efficient as normal or are otherwise ineffective to seal liquid to only the localized area. Four different types of localized liquid supply systems are illustrated in FIGS. 2-5.

One of the arrangements proposed is for a liquid supply system to provide liquid on only a localized area of the substrate and in between the final element of the projection system and the substrate using a liquid confinement system (the substrate generally has a larger surface area than the final element of the projection system). One way which has been proposed to arrange for this is disclosed in PCT patent application publication no. WO 99/49504. As illustrated in FIGS. 2 and 3, liquid is supplied by at least one inlet onto the substrate, desirably along the direction of movement of the substrate relative to the final element, and is removed by at least one outlet after having passed under the projection system. That is, as the substrate is scanned beneath the element in a −X direction, liquid is supplied at the +X side of the element and taken up at the −X side. FIG. 2 shows the arrangement schematically in which liquid is supplied via inlet and is taken up on the other side of the element by outlet which is connected to a low pressure source. The arrows above the substrate W illustrate the direction of liquid flow, and the arrow below the substrate W illustrates the direction of movement of the substrate table. In the illustration of FIG. 2 the liquid is supplied along the direction of movement of the substrate relative to the final element, though this does not need to be the case. Various orientations and numbers of in- and out-lets positioned around the final element are possible, one example is illustrated in FIG. 3 in which four sets of an inlet with an outlet on either side are provided in a regular pattern around the final element. Arrows in liquid supply and liquid recovery devices indicate the direction of liquid flow.

A further immersion lithography solution with a localized liquid supply system is shown in FIG. 4. Liquid is supplied by two groove inlets on either side of the projection system PS and is removed by a plurality of discrete outlets arranged radially outwardly of the inlets. The inlets and outlets can be arranged in a plate with a hole in its center and through which the projection beam is projected. Liquid is supplied by one groove inlet on one side of the projection system PS and removed by a plurality of discrete outlets on the other side of the projection system PS, causing a flow of a thin film of liquid between the projection system PS and the substrate W. The choice of which combination of inlet and outlets to use can depend on the direction of movement of the substrate W (the other combination of inlet and outlets being inactive). In the cross-sectional view of FIG. 4, arrows illustrate the direction of liquid flow in inlets and out of outlets.

In European patent application publication no. EP 1420300 and United States patent application publication no. US 2004-0136494, each hereby incorporated in their entirety by reference, the idea of a twin or dual stage immersion lithography apparatus is disclosed. Such an apparatus is provided with two tables for supporting a substrate. Leveling measurements are carried out with a table at a first position, without immersion liquid, and exposure is carried out with a table at a second position, where immersion liquid is present. In an arrangement, the apparatus has only one table, or has two tables of which only one can support a substrate.

PCT patent application publication no. WO 2005/064405 discloses an all wet arrangement in which the immersion liquid is unconfined. In such a system the whole top surface of the substrate is covered in liquid. This may be advantageous because then the whole top surface of the substrate is exposed to the substantially same conditions. This has an advantage for temperature control and processing of the substrate. In WO 2005/064405, a liquid supply system provides liquid to the gap between the final element of the projection system and the substrate. That liquid is allowed to leak (or flow) over the remainder of the substrate. A barrier at the edge of a substrate table prevents the liquid from escaping so that it can be removed from the top surface of the substrate table in a controlled way. Although such a system improves temperature control and processing of the substrate, evaporation of the immersion liquid may still occur. One way of helping to alleviate that problem is described in United States patent application publication no. US 2006/0119809. A member is provided which covers the substrate in all positions and which is arranged to have immersion liquid extending between it and the top surface of the substrate and/or substrate table which holds the substrate.

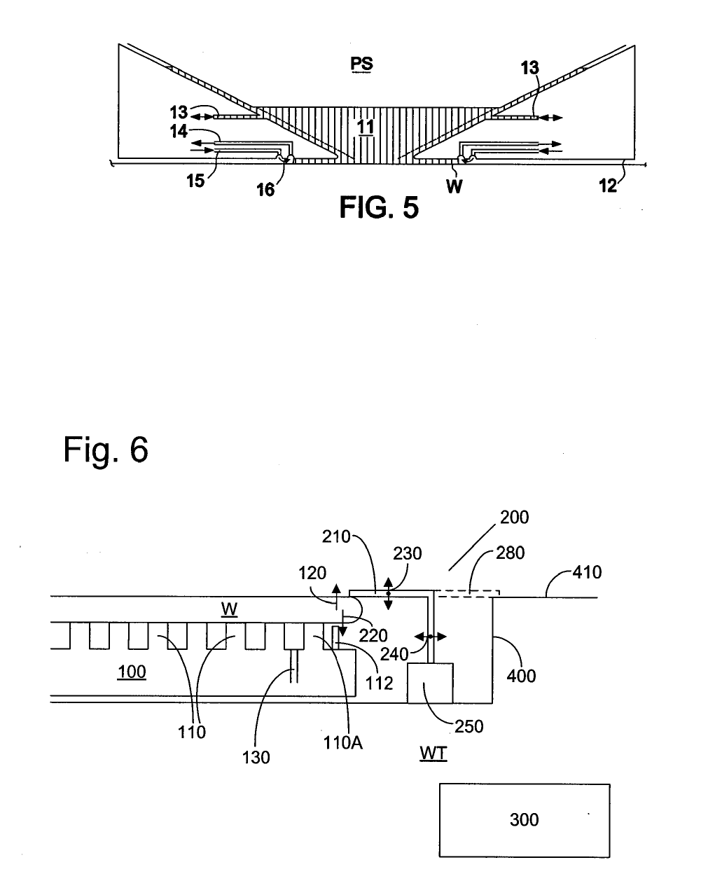

Another arrangement which has been proposed is to provide the liquid supply system with a fluid handling structure. The fluid handling structure may extend along at least a part of a boundary of the space between the final element of the projection system and the substrate table. Such an arrangement is illustrated in FIG. 5. The fluid handling structure is substantially stationary relative to the projection system in the XY plane though there may be some relative movement in the Z direction (in the direction of the optical axis). A seal is formed between the fluid handling structure and the surface of the substrate. In an embodiment, a seal is formed between the fluid handling structure and the surface of the substrate and may be a contactless seal such as a gas seal. Such a system is disclosed in United States patent application publication no. 2004-0207824. In another embodiment the fluid handling structure has a seal which is a non-gaseous seal, and so may be referred to as a liquid confinement structure.

FIG. 5 schematically depicts a localized liquid supply system or fluid handling structure or device IH with a body 12 forming a barrier member or liquid confinement structure, which extends along at least a part of a boundary of the space 11 between the final element of the projection system PS and the substrate table WT or substrate W. (Please note that reference in the following text to surface of the substrate W also refers in addition or in the alternative to a surface of the substrate table WT, unless expressly stated otherwise.) The liquid handling structure is substantially stationary relative to the projection system PS in the XY plane though there may be some relative movement in the Z direction (generally in the direction of the optical axis). In an embodiment, a seal is formed between the body 12 and the surface of the substrate W and may be a contactless seal such as a gas seal or fluid seal.

The fluid handling structure at least partly contains liquid in the space 11 between a final element of the projection system PS and the substrate W. A contactless seal, such as a gas seal 16, to the substrate W may be formed around the image field of the projection system PS so that liquid is confined within the space 11 between the substrate W surface and the final element of the projection system PS. The space 11 is at least partly formed by the body 12 positioned below and surrounding the final element of the projection system PS. Liquid is brought into the space 11 below the projection system PS and within the body 12 by liquid inlet 13. The liquid may be removed by liquid outlet 13. The body 12 may extend a little above the final element of the projection system PS. The liquid level rises above the final element so that a buffer of liquid is provided. In an embodiment, the body 12 has an inner periphery that at the upper end closely conforms to the shape of the projection system PS or the final element thereof and may, e.g., be round. At the bottom, the inner periphery closely conforms to the shape of the image field, e.g., rectangular, though this need not be the case. The inner periphery may be any shape, for example the inner periphery may conform to the shape of the final element of the projection system. The inner periphery may be round.

The liquid is contained in the space 11 by the gas seal 16 which, during use, is formed between the bottom of the body 12 and the surface of the substrate W. The gas seal 16 is formed by gas, e.g. air or synthetic air but, in an embodiment, N₂ or another inert gas. The gas in the gas seal 16 is provided under pressure via inlet 15 to the gap between body 12 and substrate W. The gas is extracted via outlet 14. The overpressure on the gas inlet 15, vacuum level on the outlet 14 and geometry of the gap are arranged so that there is a high-velocity gas flow inwardly that confines the liquid. The force of the gas on the liquid between the body 12 and the substrate W contains the liquid in a space 11. The inlets/outlets may be annular grooves which surround the space 11. The annular grooves may be continuous or discontinuous. The flow of gas is effective to contain the liquid in the space 11. Such a system is disclosed in United States patent application publication no. US 2004-0207824.

The example of FIG. 5 is a so called localized area arrangement in which liquid is only provided to a localized area of the top surface of the substrate W at any one time. Other arrangements are possible, including fluid handling structures which make use of a single phase extractor or a two phase extractor as disclosed, for example, in United States patent application publication no US 2006-0038968. In an embodiment, a single or two phase extractor may comprise an inlet which is covered in a porous material. In an embodiment of a single phase extractor the porous material is used to separate liquid from gas to enable single-liquid phase liquid extraction. A chamber downstream of the porous material is maintained at a slight under pressure and is filled with liquid. The under pressure in the chamber is such that the meniscuses formed in the holes of the porous material prevent ambient gas from being drawn into the chamber. However, when the porous surface comes into contact with liquid there is no meniscus to restrict flow and the liquid can flow freely into the chamber. The porous material has a large number of small holes, e.g. of diameter in the range of 5 to 300 μm, desirably 5 to 50 μm. In an embodiment, the porous material is at least slightly lyophilic (e.g., hydrophilic), i.e. having a contact angle of less than 90° to the immersion liquid, e.g. water.

In an embodiment which is an immersion lithographic apparatus, the exact type of immersion lithographic apparatus (be it localized liquid, wet, bath etc.) is not important. Furthermore, the particular type of fluid handling system is not relevant either and the invention is applicable to all types of fluid handling system.

A coating on a substrate W can have the effect of bending the edge of a substrate W up or down after attaching the substrate W to a substrate support 100 of a substrate table WT. Additionally, a coating can have a thickness variation which can result in variation in the flatness of a substrate W edge. Another source of variation in the flatness of a substrate W edge is variation in the thickness of a substrate W, for example due to polishing. If more material is removed from the top of the substrate W at a particular position at the edge, this will lead to an uneven surface at the edge. Additionally, if more material is removed from the bottom side of a substrate W, when the substrate W is attached to the substrate support 100, this can lead to bending downwards of the substrate W edge. A systematically or unsystematically contaminated edge of a substrate W backside or of a substrate support 100 can cause unflatness at the edge of a substrate W, for example to change over time. Wear can decrease edge performance over time. An embodiment of the present invention can extend the useful lifetime of an apparatus by compensating for change in edge performance over time.

Unflatness at the edge of a substrate W can lead to poor levelling and thereby poor focus performance. Although it is possible to measure the surface of the substrate W prior to imaging to determine the level of all parts of the substrate W and to vary the height of the substrate W during imaging, this can be computationally expensive and can result in loss of throughput. Additionally, if an edge is curved, it may not be possible to maintain a whole field in focus at the edge. For example one part of the field may be further than the focal distance from the projection system PS whereas another part of the field may be closer than the focal distance to the projection system PS. In that case a best fit for focal distance needs to be chosen and this is necessarily a compromise. Additionally, local tilt of the substrate edge can result in poor overlay performance.

Therefore, it is desirable to maintain the edge of a substrate as flat as possible. This improves overlay performance at the substrate edge and results in a higher yield because more of the available dies on the substrate can be used.

If a systematic error in flatness at the edge of a substrate W is present, passive techniques can be used to bend the edge of the substrate W, when positioned on the substrate support 100, in the desired direction. Some passive techniques are described below, for example, with reference to FIG. 6.

Active techniques to correct edge flatness are also or alternatively available as follows. The flatness of the edge of the substrate W is measured, for example outside of the lithographic apparatus, at a measuring position in a lithographic apparatus, or at the exposure position of the lithographic apparatus. In an embodiment the flatness of the edge of the substrate W is measured when the substrate is mounted on the substrate support. According to the results of the measurement, an active method may be used to apply a force to the edge of the substrate W, thereby to bend the edge of the substrate and compensate for the unflatness. After the compensation force has been applied, it is possible to re-measure the flatness of the substrate W. After re-measuring the flatness of the substrate W, the substrate W may be imaged or, if necessary, it is possible to re-measure the flatness of the edge and re-adjust the force applied to the edge of the substrate W as necessary. This loop can be completed as many times as is necessary or as is desired.

This process may be carried out for each substrate or alternatively just for one substrate per batch, with the same bending force being applied to each substrate W. In an embodiment, the adjustment force is determined from a look-up table according to the measured flatness.

FIG. 6 illustrates a substrate table WT with an associated substrate support 100 comprising a plurality of projections (burls) 110. A substrate W is supported on the substrate support 100. The substrate support 100 is adapted to apply a bending force to an edge of the substrate W in a first direction 120.

In an embodiment, the substrate support 100 is an electrostatic substrate support. That is, the substrate W is held to the substrate support 100 by an electrostatic force. In an embodiment, the substrate support 100 sucks the substrate W to it by generating an underpressure between the substrate W and the substrate support 100. Reference hereinafter to underpressure should also be read as reference to electrostatic force as the same principles as described with reference to an underpressure substrate support 100 apply equally to an electrostatic substrate support.

The bending force may be applied by the substrate support 100 in a variety of different ways. The substrate support 100 operates by applying an under pressure between the substrate support 100 and the substrate W thereby to pull the substrate W down towards the substrate support 100 and so that the substrate W rests on a top surface of the projections 110.

The bending force may be applied to the substrate W by active or passive variation in the under pressure (which is applied through one or more openings 130) or by active or passive variation in one or more of the projections 110. For example, in an embodiment the position of the outer most projection 110A may be shifted closer to or further from an edge of the substrate W thereby to vary the bending force on the edge of the substrate W. In an embodiment the pitch between projections 110, the stiffness, the plan cross sectional area and/or the height of the projections 110 may be such that a force in the first direction 120 is applied by the substrate support 100 to the substrate W. In an active system the plan position and/or cross sectional height of the projections 110 may be adjustable, for example using a piezoelectric actuator.

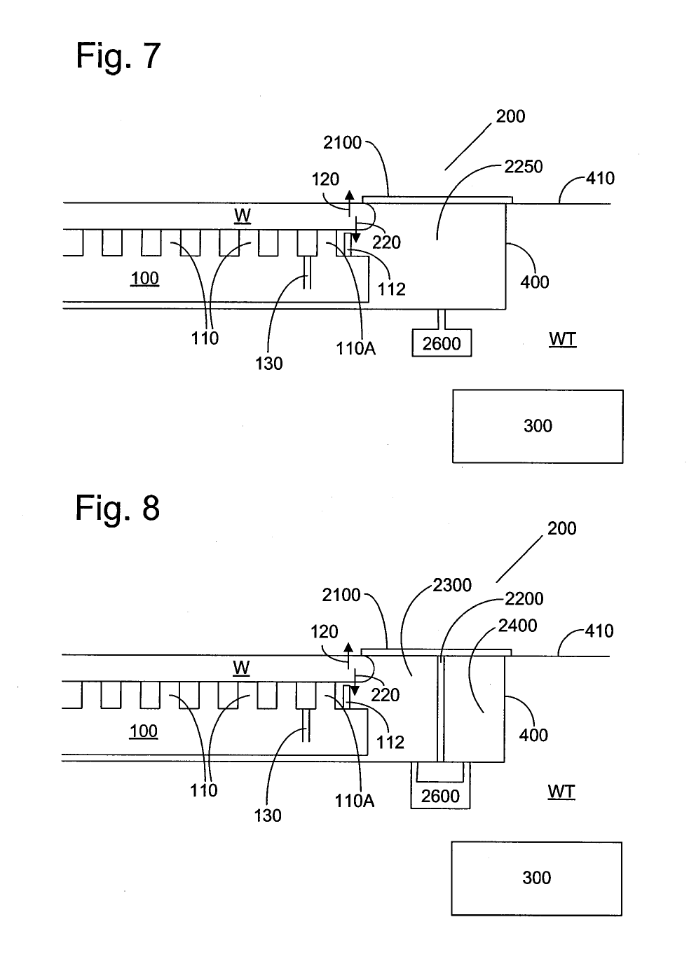

A seal 112 is provided at the edge of the substrate support 110. The seal 112 separates the space under the substrate W from the space between the substrate edge and the substrate table WT. In an embodiment the seal 112 contacts the undersurface of the substrate W. In an embodiment the seal 112 does not contact the undersurface of the substrate W and the gap between the undersurface of the substrate W and the top of the seal 112 is dimensioned such that little fluid seeps between the substrate W and the seal 112 to move past the seal to the left or right of the seal 112, as illustrated. The seal 112 may be annular, for example. The seal 112 allows the underpressure used to hold the substrate W to the substrate support 100 to be optimized without interfering with the underpressure radially outwardly of the seal 112 in the gap between the edge of the substrate W and the substrate table WT. This is useful, in particular, in an immersion lithography apparatus where steps may be taken to extract liquid from the gap between the edge of the substrate W and the edge of the substrate table WT. In the embodiments of FIGS. 7 and 8 below, the seal 112 allows the force applied by the substrate edge manipulator 200 to the edge of the substrate W to be adjusted independently of the force applied by the substrate support 100 to the substrate W.

In an embodiment the amount of bend induced in the substrate W is determined by local under pressure applied between the edge of the substrate W and the substrate support 100.

In an embodiment, as illustrated in FIG. 6, a substrate edge manipulator 200 is provided. The substrate edge manipulator 200 comprises a member 210. The member 210, in use, makes physical contact with an upper major face of the substrate W, desirably at the edge of the substrate W. Through the physical contact of the member 210 with the upper major face of the substrate W, a bend in the edge of the substrate W can be induced. That is, the member 210 applies a bending force to the edge of the substrate W in direction 220. In an embodiment direction 220 has at least a component in an opposite direction to direction 120. In an embodiment direction 120 is in the same direction as direction 220.

In an embodiment the member 210 is configured to apply a variable force to the edge of the substrate W. The member 210 may be actuated in directions illustrated by arrow 230 in order to apply a variable force to the edge of the substrate W and/or in order to allow positioning of the substrate W on the substrate support 100.

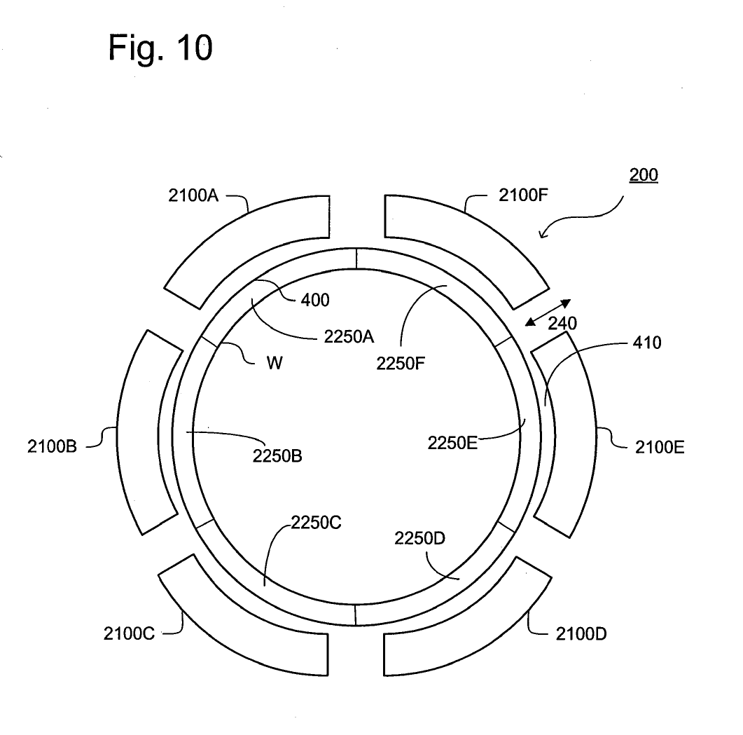

In an embodiment, also illustrated in FIG. 10, the member 210 is positionable in directions illustrated by arrow 240. Movement in directions 240 may allow easier loading of the substrate W on the substrate support 100.

The member 210 may be actuated by an actuator 250. The actuator 250 may, for example, be a piezoelectric actuator, an electromagnetic actuator, a pneumatic actuator, an electrostatic actuator, etc. In an embodiment the actuator 250 is attached to the substrate table WT. In an embodiment the actuator 250 is attached to the substrate support 100.

A measuring device 600 (illustrated in FIG. 1) to measure the flatness of the substrate W generates a signal indicative of the flatness of the edge of the substrate W. The measurement may take place with no force applied to the substrate W, or only a nominal (passive) force from one or both of the substrate support 100 and member 210. This signal is sent to a controller 300 which controls the actuator 250 accordingly. That is, the actuator 250 is actuated to vary the force the member 210 applies to the edge of the substrate W such that the flatness of the edge of the substrate W is improved compared to the flatness of the edge of the substrate W in the absence of the force applied by the member 210.

In an embodiment the controller 300 receives a signal indicative of the position of the substrate table WT relative to a reference position (e.g. a position under the projection system PS of the apparatus). Based on this signal the actuator 250 is controlled so that the member 210 applies a desired force to the substrate W. In this way, if the flatness around the periphery of the edge of the substrate W varies, the force applied to the edge of the substrate W can be varied according to what part of the edge of the substrate W is currently under the projection system PS. Therefore, when a part of the edge of a substrate W with a large deviation from flat is being imaged, a large force can be applied by the member 210 to the edge of the substrate W. Conversely when a part of the edge of a substrate W which has been measured as being quite flat is under the projection system PS, a lower force can be applied by the member 210 to the edge of the substrate W. FIG. 10 illustrates an alternative arrangement in which the substrate edge manipulator 200 is segmented around the periphery of the substrate W so that a local force can be applied to the edge of the substrate W suitable to correct the local deviation from flat.

In an embodiment the measuring device 600 to measure the flatness of the substrate W may measure the flatness of the substrate W when no force either in direction 210 or 220 is applied to the substrate W. In an embodiment the measuring device 600 may measure the flatness of the substrate W when only force 120 applied by the substrate support 100 is present. In an embodiment the measuring device 600 may measure the flatness of the substrate W when a certain force, for example a predetermined force is applied by the substrate edge manipulator 200 to the edge of the substrate W. Any variation from flatness detected can be corrected by changing the force applied by the substrate edge manipulator 200 to the edge of the substrate W. This can be based on a look-up table which equates a certain deviation from flatness with a certain change in force.

In an embodiment the substrate table WT is used to apply a force to an edge of the substrate in the first direction 120 irrespective of the flatness of the edge of the substrate W. The substrate support 100 may apply the force to the substrate W in a passive manner and/or in a manner which does not vary in a batch from substrate to substrate or from batch to batch. Any one of the above mentioned ways of applying a force to the edge may be used including due to the geometry of the substrate support 100 (in particular the geometry of the projections 110), due to differences in mechanical properties of the projections 110, and/or due to variation in under pressure between the substrate W and substrate support 100 at a center of the substrate W compared to an edge of the substrate W.

In an embodiment, after the substrate W has been placed on the substrate support 100, the flatness of the edge is measured. According to the flatness of the edge, the force applied by the member 210 of the substrate edge manipulator 200 is varied thereby to improve the flatness of the edge.

The above method can be seen as deliberately inducing with the substrate support 100 a bend in the edge of the substrate W away from the substrate support 100 and then correcting this bend by application of the bending force applied by the member 210. This has an advantage that only one active component (the substrate edge manipulator 200) is used to improve flatness of a substrate W edge irrespective of whether it bends in the up or down direction (relative to the substrate support 100).

In an embodiment, bending in the up and down directions 120, 220 can be achieved by the substrate support 100 (e.g. by use of the geometry of the projections 110 and varying the under pressure respectively). Thus, the substrate support 100 acts as a substrate edge manipulator.

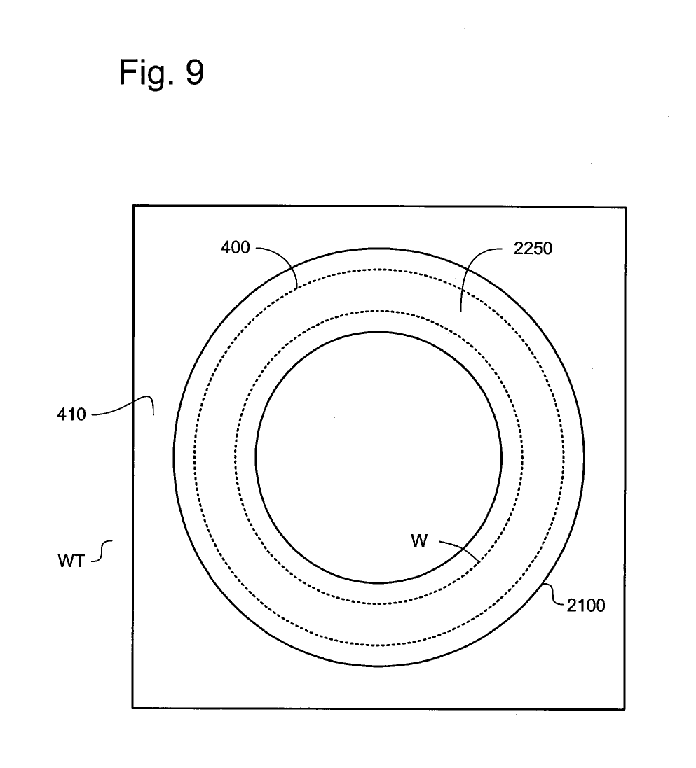

In an embodiment, the member 210 extends between a gap between the edge of the substrate W and the edge of a top surface 410 of the substrate table WT. This is illustrated in FIG. 6 in dotted lines as an extension 280 to the member 210. Thereby the substrate edge manipulator 200 may be a seal which seals the gap between the edge of the substrate W and the top surface 410 of the substrate table WT. The member 210 and extension 280 form a cover that, in use, extends around the substrate W from the upper surface 410 of the substrate table WT to a peripheral section of an upper major surface of the substrate W, the cover defining an open central portion thereby to allow exposure of the upper major face of the substrate W to the beam PB. The size of the open central portion may be slightly smaller than the size of the upper surface of the substrate W. As shown in FIG. 9, if the substrate W is circular in shape, the cover may be generally annular in shape when viewed in plan.

The arrangement of the member 210, extension 280 and actuator 250 may be similar to the cover and actuator disclosed in United States patent application publication no. US 2011/0013169, which is incorporated herein its entirety by reference, except that the member 210 is effective to bend the edge of the substrate W.

FIG. 7 illustrates a substrate table WT, in cross-section, of an embodiment. The embodiment of FIG. 7 is the same as that of FIG. 6 except as described below.

In FIG. 7 the substrate edge manipulator 200 comprises a cover 2100 which forms a seal between the edge of the substrate W and the edge of a recess 400 in which the substrate W is positioned. The cover 2100 is held in place by an under pressure generated in the cavity 2250 defined between the substrate table WT, the cover 2100 and the substrate W. The under pressure holds the cover 2100 in place. The under pressure is generated by an under pressure source 2600 and the force the cover 2100 applies to the edge of the substrate W can be varied by varying the magnitude of the under pressure. The under pressure may be, for example, a vacuum, an electrostatic force, a magnetic force, etc.

FIG. 8 illustrates a further embodiment of a substrate table, in cross-section. The embodiment of FIG. 8 is the same as that of FIG. 7 except as described below.

In the embodiment of FIG. 8 a cover seat 2200 is provided. The cover 2100 rests on the cover seat 2200 so that two cavities 2300, 2400 are defined under the cover 2100. A first cavity 2300 is defined on the side of the substrate W. The under pressure applied by the under pressure source 2600 to the first cavity 2300 determines the force applied by the cover 2100 to the edge of the substrate W. The second cavity 2400 is between the cover seat 2200 and the substrate table WT. The under pressure applied in the second cavity 2400 by the under pressure source 2600 determines the force with which the cover 2100 is held to the substrate table WT. That force as well as the force with which the cover 2100 contacts the substrate W should be enough to avoid lifting off of the cover 2100 by any forces applied to the cover 2100, particularly by a fluid handling system. The under pressure may be, for example, a vacuum, an electrostatic force, a magnetic force, etc.

In an embodiment the under pressure source can independently vary the under pressure to the first and second cavities 2300, 2400.

The embodiments in which the substrate edge manipulator 200 forms a seal over the gap between the substrate W and the substrate table WT are advantageous for use in immersion lithography. In immersion lithography a difficulty can arise with liquid and/or gas being trapped in the gap between the edge of the substrate W and the substrate table WT. By providing a cover 2100, any such problems are circumvented or reduced.

A typical under pressure in the cavity 2300, 2400 may be 50 to 100 mbar. Typically a 10 nm variation from flat may require an additional under pressure of 10 mbar.

In the embodiment where the substrate edge manipulator 200 comprises a seal, it is generally necessary to apply a force onto the substrate W in direction 220 in any case to ensure a good seal. Therefore, deliberately bending the edge of the substrate Win direction 120 by use of the substrate support 110 and correcting that by varying the force does not increase the complexity of the system as the under pressure would be applied in any case.

FIG. 9 illustrates, in plan, a cover 2100 according to the embodiment of FIG. 7. FIG. 9 shows how the cover 2100 extends over the cavity 2250 and over the edge of the substrate W and the edge of the recess 400.

FIG. 10 illustrates an embodiment of the invention, in plan. In FIG. 10 the substrate edge manipulator 200 comprises six covers 2100A-F. Any number of covers 2100A-F could be provided. The cover 2100 of FIG. 6, 7 or 8 may be segmented so that the deviation at a local position along the periphery of the substrate W from flatness may be corrected locally rather than use of a global correction. Thus, each of the covers 2100A-F may apply a force suitable for correction of the local flatness of the edge of the substrate W to which it is associated. For this purpose individual cavities 2250A-F may be provided between the substrate W and the substrate table WT associated with each of the covers 2100A-F if, for example, the substrate edge manipulator 200 with under pressure 2600 of FIG. 7 is being implemented.

As will be appreciated, any of the above described features can be used with any other feature and it is not only those combinations explicitly described which are covered in this application.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of or about 365, 248, 193, 157 or 126 nm). The term “lens”, where the context allows, may refer to any one or combination of various types of optical components, including refractive and reflective optical components.

While specific embodiments of the invention have been described above, it will be appreciated that the invention may be practiced otherwise than as described. For example, the embodiments of the invention may take the form of a computer program containing one or more sequences of machine-readable instructions describing a method as disclosed above, or a data storage medium (e.g. semiconductor memory, magnetic or optical disk) having such a computer program stored therein. Further, the machine readable instruction may be embodied in two or more computer programs. The two or more computer programs may be stored on one or more different memories and/or data storage media.

The controllers described herein may each or in combination be operable when the one or more computer programs are read by one or more computer processors located within at least one component of the lithographic apparatus. The controllers may each or in combination have any suitable configuration for receiving, processing, and sending signals. One or more processors are configured to communicate with the at least one of the controllers. For example, each controller may include one or more processors for executing the computer programs that include machine-readable instructions for the methods described above. The controllers may include data storage medium for storing such computer programs, and/or hardware to receive such medium. So the controller(s) may operate according the machine readable instructions of one or more computer programs.

One or more embodiments of the invention may be applied to any immersion lithography apparatus, in particular, but not exclusively, those types mentioned above and whether the immersion liquid is provided in the form of a bath, only on a localized surface area of the substrate, or is unconfined. In an unconfined arrangement, the immersion liquid may flow over the surface of the substrate and/or substrate table so that substantially the entire uncovered surface of the substrate table and/or substrate is wetted. In such an unconfined immersion system, the liquid supply system may not confine the immersion liquid or it may provide a proportion of immersion liquid confinement, but not substantially complete confinement of the immersion liquid.

A liquid supply system as contemplated herein should be broadly construed. In certain embodiments, it may be a mechanism or combination of structures that provides a liquid to a space between the projection system and the substrate and/or substrate table. It may comprise a combination of one or more structures, one or more fluid openings including one or more liquid openings, one or more gas openings or one or more openings for two phase flow. The openings may each be an inlet into the immersion space (or an outlet from a fluid handling structure) or an outlet out of the immersion space (or an inlet into the fluid handling structure). In an embodiment, a surface of the space may be a portion of the substrate and/or substrate table, or a surface of the space may completely cover a surface of the substrate and/or substrate table, or the space may envelop the substrate and/or substrate table. The liquid supply system may optionally further include one or more elements to control the position, quantity, quality, shape, flow rate or any other features of the liquid.

The descriptions above are intended to be illustrative, not limiting. Thus, it will be apparent to one skilled in the art that modifications may be made to the invention as described without departing from the scope of the claims set out below.

1. A substrate table to support a substrate, the substrate table comprising:
a substrate support configured to support the substrate and to apply a bending force to an edge of the substrate in a first direction; and
a substrate edge manipulator configured to apply a variable bending force to the edge of the substrate in a second direction, the second direction having at least a component opposite in direction to the first direction.

2. The substrate table of claim 1, further comprising a controller configured to control the bending force applied to the edge of the substrate by the substrate edge manipulator based on a signal.

3. The substrate table of claim 2, wherein the signal is a signal (i) indicative of a flatness of the edge of the substrate when supported on the substrate support and/or (ii) indicative of the position of the substrate table relative to a reference position.

4. The substrate table of claim 2, wherein the controller is configured to control the bending force applied to the edge of the substrate by the substrate edge manipulator to induce a bend of the substrate edge in the second direction to improve the flatness at the edge of the substrate on the substrate support compared to the flatness in the absence of the bending force applied by the substrate edge manipulator.

5. The substrate table of claim 1, wherein the substrate support is configured to apply its bending force to the edge of the substrate due to the geometry of the substrate support.

6. The substrate table of claim 1, wherein the substrate support is configured to apply its bending force to the edge of the substrate due to differences in mechanical properties of projections on which, in use, the substrate is supported.

7. The substrate table of claim 1, wherein the substrate support is configured to apply its bending force to the edge of the substrate by varying an under pressure between the substrate and the substrate support at the edge of the substrate compared to the center of the substrate.

8. The substrate table of claim 1, wherein the substrate edge manipulator is a seal which, in use, seals a gap between the edge of the substrate and a top surface of the substrate table.

9. The substrate table of claim 1, wherein the substrate edge manipulator comprises a mechanical manipulator which, in use, physically contacts the substrate.

10. The substrate table of claim 9, wherein the substrate edge manipulator comprises a cover that, in, use, extends around the substrate from an upper surface of the substrate table to a peripheral section of an upper major face of the substrate, the cover defining an open central portion.

11. The substrate table of claim 1, wherein the substrate edge manipulator is configured to apply its variable bending force through one or more selected from:
an under pressure source, an electromagnetic actuator, a piezoelectric actuator, or an electrostatic actuator.

12. The substrate table according to claim 1, wherein the substrate table is adapted for use in an immersion lithographic apparatus.

13. A substrate table to support a substrate, the substrate table comprising:
a member configured, in use, to bend an edge of a substrate supported by the substrate table by physical contact with an upper major face of the substrate.

14. The substrate table of claim 13, wherein the member is a seal which, in use, seals a gap between the edge of the substrate and a top surface of the substrate table.

15. The substrate table of claim 13, wherein the member is configured to bend the edge of the substrate by applying a variable force through one or more selected from:
an under pressure source, an electromagnetic actuator, a piezoelectric actuator, or an electrostatic actuator.

16. The substrate table of claim 13, wherein the member comprises a cover, that, in use, extends around the substrate from an upper surface of the substrate table to a peripheral section of an upper major face of the substrate, the cover defining an open central portion.

17. A lithographic apparatus comprising:
a substrate table to support a substrate, comprising:
a substrate support to support the substrate and to apply a bending force to an edge of the substrate in a first direction, and
a substrate edge manipulator adapted to apply a variable bending force to the edge of the substrate in a second direction, the second direction having at least a component opposite in direction to the first direction; and
a projection system configured to project a patterned beam of radiation onto the substrate on the substrate table.

18. The lithographic apparatus of claim 17, further comprising a measuring device to measure a flatness of a substrate.

19. A method of flattening an edge of a substrate, the method comprising:
applying a force to an edge of the substrate sufficient to induce the edge of the substrate to bend in a first direction; and
applying a variable force to the edge of the substrate in a second direction substantially opposite in direction to the first direction to improve the flatness of the edge of the substrate.

20. The method of claim 19, further comprising projecting a patterned beam of radiation onto a target portion of the substrate.
